(19) United States
(12) Patent Application Publication
(10) Pub. No.: US 2003/0136095 A1
(43) Pub. Date: Jul. 24, 2003

(54) Impact collector with direct and indirect impact surfaces

(76) Inventors: David J. Walker, Wadsworth, OH (US); Mikhail Maryamchik, Copley, OH (US); Donald L. Wietzke, Carlsbad, CA (US)

Correspondence Address: ERIC MARICH, THE BABCOCK & WILCOX COMPANY, PATENT DEPARTMENT, 20 S. Van Buren Avenue, Barberton, OH, 44203, US

(21) Appl. No.: 10/056,148

(22) Filed: Jan. 24, 2002

(51) Int. Cl. B01D 45/00

(52) U.S. Cl. 55/434.4

(57) ABSTRACT

A separator array for a furnace has large scale collection elements which can be formed from water-cooled tube walls and permit walk-through inspection and repair. The collection elements have direct impact surfaces, indirect impact surfaces and stagnation retainer surfaces. The array uses fewer, but larger collection elements than known separator arrays to provide at least the same solids collection efficiency while permitting the use of lower cost materials and easier inspection and repair.

### FIELD AND BACKGROUND OF THE INVENTION

1. Field of the Invention

The present invention relates generally to the field of gas-solids separators for power generation furnaces, boilers and reactors, and in particular to a new and useful impact-type separator collection element and arrays thereof.

2. Description of the Related Art

Impact collectors of several different configurations are known in the art. One common feature of known impact collector configurations is a staggered array of collector elements having relatively small gaps of one to eight inches between rows of collection elements and between adjacent collection elements. The collection elements are typically also relatively small scale 2 to 10 inches in cross section compared to the enclosures inside which they are used.

The collection or separation of particles from flowing flue gases occurs in conventional impact collectors as a result of forcing the flue gases and entrained solids to follow a tortuous path across a staggered array of collection elements having these relatively small scale dimensions and sharp edges. The collection elements are shaped to enable solids which enter to directly impact the back of the element and fall by gravity to a discharge opening at the bottom and inside of the small scale collection element, unaffected by the flue gases flowing past the collection element. The open sides of the collection elements commonly face the gas flow. A U-beam is a very common shape for the collection elements.

In boilers and furnaces, the operating temperature of the application requires that collection elements are made from stainless steel if a plate material is used in order to withstand erosion and corrosion, as well as for strength. Over time, damage to the collection elements still occurs from wear and the elevated temperatures experienced inside boilers and furnaces.

However, individual collection elements are spaced closely together, as discussed above. The close spacing results in limited access to the individual elements for inspection or maintenance within the array. With close spaced arrays, the only good option for inspecting the entire array is to temporarily remove some of the individual collection elements to gain access to others.

Existing impact separators generally are made from austenitic steel alloys. Austenitic alloys are relatively expensive compared to other, lower alloys. Thus, it is preferable to utilize lower alloy materials whenever permitted by operating constraints to obtain the resulting reduction of cost, and ease of procurement of replacement parts, when needed.

Water tubes are commonly used in boilers and furnaces to effect heat transfer from the combustion products and flue gases to generate steam, and to cool the components the tubes form. It is generally known in the field of furnace and boiler design that water tubes and walls in a boiler can be protected from erosion and corrosion by applying some sort of covering over the tubes. Typically, the coverings are alloy shields, ceramic tiles, refractory or a spray coating. Tubes and their coverings are generally more accessible for repair and inspection because they are used for larger structures in boilers, such as enclosure walls. Water tubes are typically relatively larger in scale than separator collection elements.

However, since cooled tubes are typically connected into inlet and outlet manifolds and piping, removal of individual collection elements for access is not practical. Adequate access can be created by scale up of individual collection elements to the extent that the proportionally sized gaps between individual collection elements would enable workmen to gain access between and amongst the collection elements. This change in turn requires an increase in scale of conventional collection elements by a factor of 34 times or more compared to current designs. But, due to the change in particle flow dynamics around larger collection elements, collection efficiency of conventional arrays made of large collection elements suffers in comparison to collectors of smaller scale.

### SUMMARY OF THE INVENTION

It is an object of the present invention to provide an impact-type separator collection element which is made from lower steel alloys.

A further object of the invention is to provide a separator collection element which includes a fluid-cooled tube.

Yet another object of the invention is to provide a large scale separator array with sufficient spacing between collection elements in a separator to permit walk-through inspection and repair of the elements, while maintaining solids collection efficiency.

Accordingly, an impact-type separator collection element is provided having direct impact surfaces, indirect impact surfaces and stagnation retainer surfaces. The collection elements are significantly larger than conventional elements, so that walk through inspection is possible between staggered rows of the array. Indirect impact surfaces are formed from plates oriented parallel to the furnace enclosure side walls and extend continuously along the length of the separator. Direct impact surfaces extend perpendicular from the sides of the indirect impact surfaces in staggered rows. The direct impact surfaces of a given row are all co-linear with each other. A gap is left between the ends of the direct impact surfaces and the indirect impact surface adjacent the one the direct impact surface extends from. The free ends of the direct impact surfaces are formed in a U-shape, back toward the connected indirect impact surface to form the stagnation retainer surfaces.

Due to the increased size of the collection elements, the various surfaces may be made of water tubes and membrane bars covered with suitable materials. In such case, lower alloy materials may be used for the water tubes and membrane bars forming the surfaces. Alternatively, the surfaces may be made from plates.

The collection elements are sized to permit walk-through inspection, with the distance between elements being between 14 and 36 inches, depending on the relative sizes of the elements.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top plan view of an impact-type separator array according to the invention;

FIG. 2A is a sectional side elevation taken along line 2-2 of the separator array of FIG. 1;

FIG. 2B is a sectional side elevation of a second embodiment of the separator array of FIG. 1 taken along line 2-2; and

FIG. 2C is a sectional side elevation of a third embodiment of the separator array of FIG. 1 taken along line 2-2.

### DESCRIPTION OF THE PREFERRED EMBODIMENTS

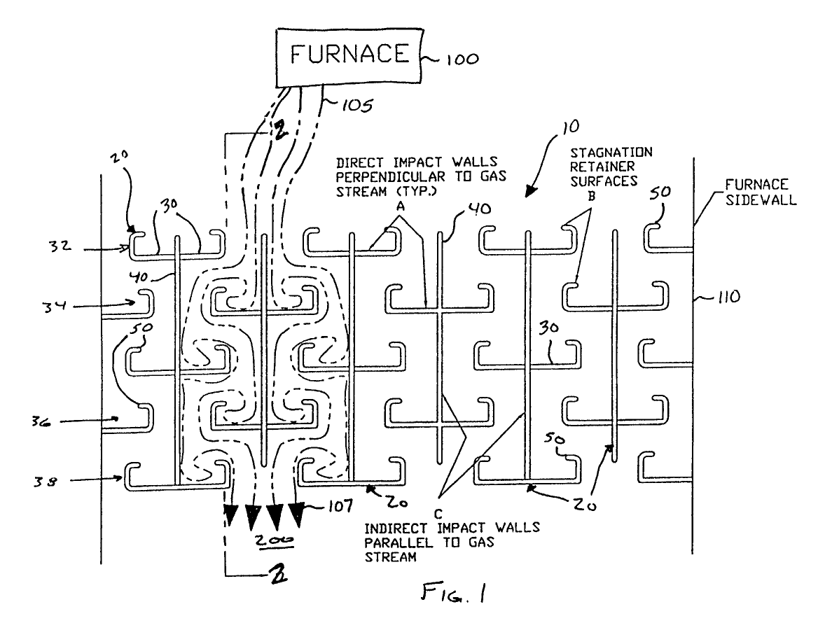

Referring now to the drawings, in which like reference numerals are used to refer to the same or functionally similar elements, FIG. 1 shows a separator array 10 for a furnace 100 or boiler of impact-type collection elements 20 arranged in staggered rows. The collection elements 20 can be supported from the roof of the furnace enclosure around the separator array 10. The collection elements 20 extend vertically through substantially the entire height of the enclosure where the separator is located. Where the collection elements 20 are positioned inside the furnace 100 combustion chamber exit, they have a length similar to collection elements 20 outside the combustion chamber exit.

The elements 20 are sized and spaced to permit visual inspection and repair by walking through the separator array 10 during non-operational periods of the furnace 100. The collection elements 20 are sufficiently large that they can be formed from water tubes and membrane bars.

Flue gases with entrained solids 105 enter the furnace side of the separator array 10 and flow through a tortured path between collection elements 20. Collection elements 20 are constructed from elongated walls, referred to as indirect impact surfaces 40 oriented parallel with the furnace side walls 110, direct impact surfaces 30 extending perpendicular from the sides of the indirect impact surfaces 30 and bent ends of the direct impact surfaces 30. The bent ends form stagnation retainer surfaces 50.

The direct impact surfaces 30 are arranged in aligned rows extending from one indirect impact surface 40 toward an adjacent indirect impact surface 40 without a direct impact surface 30 in the same row, so that a space is left between them for flue gases 105 to flow through. A direct impact surface 30 extends from the adjacent indirect impact surface 40 back toward the first indirect impact surface 40 in the row 34 immediately behind the first row 32 to create the staggered alignment of the array 10.

The stagnation retainer surfaces 50 formed at the free ends of the direct impact surfaces 30 are generally shaped as U-channels, so that a portion of the collection element 20 is bent back over the direct impact surface 30, protecting it from being struck directly by flowing gases 105. Other shapes which create a stagnant gas flow adjacent the direct impact surfaces 30 could be used as well.

Flue gases 107 substantially free of solid particles exit the separator array 10 into the convection pass 200 of the furnace 100.

The large scale array 10 relies upon the tendency of solids particles entrained in a horizontally flowing gas stream 105 which impact a vertical surface in the path of the stream 105 to remain near the vertical surface and separate from the gas stream 105. This tendency is caused primarily by the greater momentum of the solids particles in the gas stream 105 which is forced to change direction to continue flowing through the array 10, and the lower velocity flow boundary layer of gas adjacent a wall or vertical surface. Gravitational forces acting on the solids which are captured by the vertical surfaces enhance the capture effect by creating a curtain of falling solids which can absorb and entrain additional solids particles which contact or impact the falling curtain of solids.

This invention utilizes the direct impact surfaces 30, indirect impact surfaces 40 and stagnation retainer surfaces 50 to take advantage of the tendencies noted above.

In the case of the direct impact surfaces 30, the vertical walls of the separator array 10 are arranged to provide direct impact of the flue gases and entrained solids 105 on a surface 30 placed perpendicular to the direction of gas flow. The entrained solids are separated from the gas by both tendencies of the solids. That is, utilizing the greater momentum of solids particles in a gas stream which changes direction, and allowing the solids to fall under the influence of the second mechanism—the lower velocity flow boundary layer of gas adjacent to a wall or surface.

The indirect impact surfaces 40 provide vertical walls arranged more or less parallel to the flow of the gases 105. The indirect impact surfaces also require the flue gases 105 to change direction in order to continue through the array 10. The indirect impact surfaces 40 are usually on the outer side of the induced change in direction of the flue gas 105 flow. This results in the lower velocity flow boundary layer affecting the solids and causing them to separate from the gas flow. To a lesser extent, there is some tendency of particles coming near the surface to remain in that region and become separated from the gases as well.

Finally, the stagnation retainer surfaces 50 prevent the captured, falling curtain of solids from being re-entrained in the higher velocity gas flow. The stagnation retainer surfaces 50 are positioned at strategic locations to create zones along the vertical surfaces having stagnation gas velocity. The zones provide an essentially zero velocity location where the solids can be accumulated on their way to discharge openings at the bottom without become re-entrained in a gas flow.

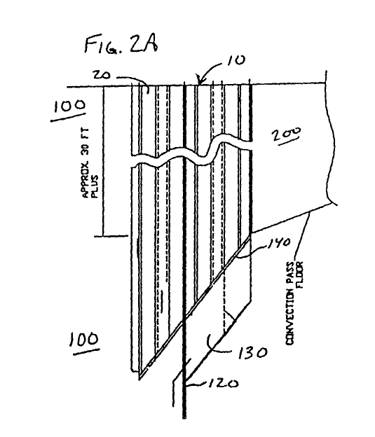

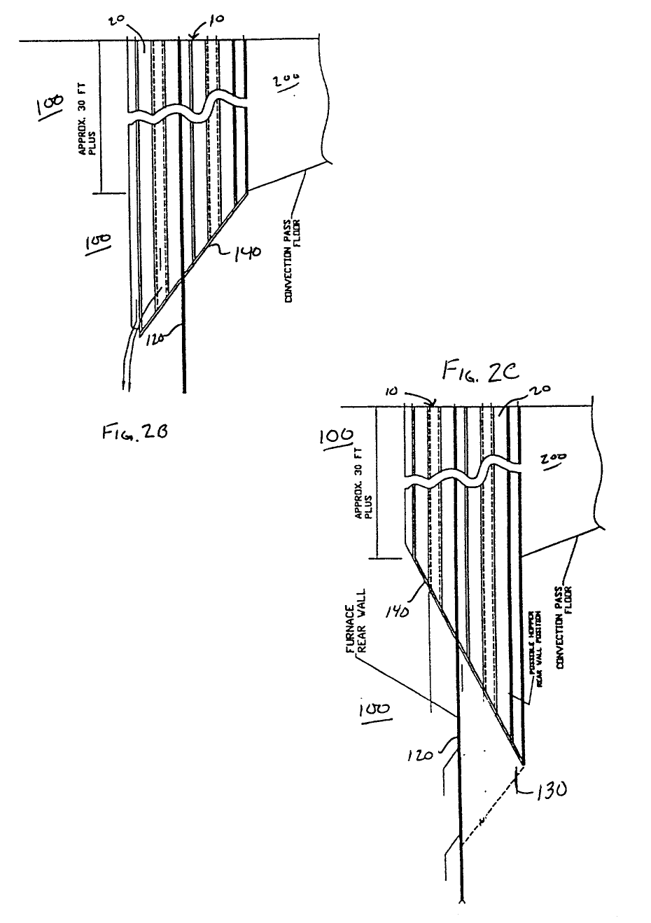

FIGS. 2A-2C illustrate three possible embodiments for the floor 140 of the separator array 10. Generally, it is preferred that the floor 140 is sloped with respect to the horizontal in order to keep the collected solids moving along the vertical surfaces, or walls, towards discharge openings adjacent the floor 140. In the case of the embodiments of FIGS. 2A and 2C, a hopper 130 is provided beneath the floor 140 to catch collected solids particles and return them to the furnace 100 combustion chamber for further combustion. In the embodiment of FIG. 2B, the solids simply slide along the floor 140 below the gas flow back into the upper regions of the furnace 100 combustion chamber. Some solids in the embodiment of FIG. 2A also slide back into the furnace 100 along the floor 100. In the embodiment of FIG. 2C, the solids are channeled only into the hopper 130 along the floor 140.

Since impact separator arrays 10 are typically located inside and/or outside the exit from a furnace combustion chamber or reactor, defined by the furnace rear wall 120, it is envisioned that the array 10 of the invention can be positioned such that one or more rows or all of the rows can be located inside the furnace 100 or reactor, or alternatively outside the furnace 100 or reactor.

The various vertical surfaces 30, 40, 50 of the collection elements 20 can be made of plates, or if temperature or construction dictate, the surfaces 30, 40, 50 can be made of water cooled tubes and membrane bar. A protective covering over the vertical surfaces can consist of alloy shields, ceramic tiles, refractory or some other resistant coating on the plate or cooled tubes and membrane bar. Cooled surfaces further permit the use of lower alloy materials, which reduce the cost relative to austenitic stainless steel components.

The scale and arrangement of the separator array 10 enables easy access through the collector elements 20 during boiler shut-down for inspection and maintenance.

The separator array 10 provides a large area of collecting surface in a given space with fewer collection elements 20, rather than requiring a large number of closely spaced, small collection elements. The separator array 10 both simplifies construction and reduces construction costs. The separator array 10 and collection elements 20 are preferably made on a scale which enables the distance between adjacent elements 20 to be from 14 to 36 inches. With the larger scale, fewer elements 20 are required and it is possible to enter the array 10 during outages for access to all surfaces.

In a preferred embodiment, the direct impact surfaces 30 are about two to three feet long. The distance between rows of direct impact surfaces 30, which is also the length of a continuous section of indirect impact surface 40, may be about 18-36 inches. The spacing between adjacent indirect impact surfaces 40 is preferably about four to five feet, so that clearance between direct impact surfaces 30 and an adjacent indirect impact surface 40 is about two to three feet. The stagnation retainer surfaces 50 are preferably shaped as U-channels oriented with the opening perpendicular to the gas flow, and one side formed by the end of the connected direct impact surface 30. The stagnation retainer channels 50 are preferably about 6-14 inches deep and 8-18 inches wide.

The larger scale of the array 10 also permits the incorporation of cooled panels, such as water tube walls, to form the vertical surfaces 30, 40, 50. Since the mechanisms for separator of solids utilized by the separator array 10 do not rely on forcing the gas to follow a tortuous path across a staggered array of collection elements having relatively small scale dimensions and relatively sharp edges, scale up to dimensions allowing easy access for inspection and maintenance is possible while maintaining good particle collection efficiency.

While a specific embodiment of the invention has been shown and described in detail to illustrate the application of the principles of the invention, it will be understood that the invention may be embodied otherwise without departing from such principles.

We claim:

1. A collection element for a separator array of a furnace or boiler generating a hot flue gas with entrained solids, the separator array having staggered rows of a plurality of collection elements for separating solids from the flue gas, each collection element comprising:
an indirect impact surface oriented parallel with the flow of the flue gas through the separator array;
a direct impact surface extending perpendicular from the indirect impact surface; and
a stagnation retainer surface at the end of the direct impact surface for generating an area of stagnant gas flow in the separator array.

2. The collection element according to claim 1, wherein the indirect impact surface, direct impact surface and stagnation retainer surface are each made of a water tube wall.

3. The collection element according to claim 2, further comprising a protective covering over the water tube walls.

4. The collection element according to claim 1, wherein the direct impact surfaces are about 2-3 feet long.

5. The collection element according to claim 4, wherein the stagnation retainer surfaces are shaped as U-channel at the end of the direct impact surface, with one leg of the U-channel formed by a portion of the direct impact surface.

6. The collection element according to claim 5, wherein the U-channel is about 614 inches deep and about 8-18 inches wide.

7. The collection element according to claim 1, wherein the indirect impact surface, direct impact surface and stagnation retainer surface are each made of a low alloy stainless steel.

8. A separator array for a furnace or reactor which generates hot flue gases with entrained solids as a by-product of combustion, the separator array located adjacent the roof of the furnace or reactor enclosure at the exit of the furnace or reactor combustion chamber to receive a flow of the hot flue gases and entrained solids, the separator array comprising:
a plurality of indirect impact surfaces arranged parallel to the flow of hot flue gases extending vertically downward from the roof;
a plurality of direct impact surfaces connected to the indirect impact surfaces, the direct impact surfaces connected extending perpendicular from the indirect impact surfaces toward adjacent ones of the indirect impact surfaces to form overlapping staggered rows defining paths between the direct impact surfaces and indirect impact surfaces; and
stagnation retainer surface means connected to the ends of each direct impact surfaces for creating a zone of stagnant gas flow adjacent the corresponding direct impact surface, wherein the indirect impact surfaces and direct impact surfaces are spaced at least about 18 inches apart.

9. The separator array according to claim 8, wherein the plurality of indirect impact surfaces and plurality of direct impact surfaces are each made of water tube walls.

10. The separator array according to claim 9, further comprising a protective covering over the water tube walls.

11. The separator array according to claim 8, wherein the direct impact surfaces are about 2-3 feet long.

12. The separator array according to claim 11, wherein the stagnation retainer surface means comprises shaped U-channels at free ends of the direct impact surface, with one leg of the U-channel formed by a portion of the direct impact surface.
